(19) United States
(12) Patent Application Publication
(10) Pub. No.: US 2012/0096048 A1
(43) Pub. Date: Apr. 19, 2012

(54) Personalized Object Dimension

(75) Inventors: Raymond Patch, Redmond, WA (US); Rajeev Chauhan, Issaquah, WA (US)

(73) Assignee: Microsoft Corporation, Redmond, WA (US)

(21) Appl. No.: 12/907,045

(22) Filed: Oct. 19, 2010

(51) Int. Cl. G06F 17/30

(52) U.S. Cl. 707/803; 707/E17.005

(57) ABSTRACT

Architecture that associates personalized information (e.g., user preferences) to an object that needs to be displayed in a custom way. The preferences are associated with the object as an inherent object dimension, in addition to the actual data (another dimension). The intrinsic actual data contained within the object itself is considered the first dimension, and additional data and/or metadata make up additional dimensions. Whenever the object is retrieved, the associated personal preferences as the inherent object dimension are returned with the object. The web developer simple uses the associated preferences to build the webpage. If no preferences were defined, the object can be configured to return with a default set of preferences.

### CROSS-REFERENCE TO RELATED APPLICATIONS

This application is related to pending U.S. patent application Ser. No. ______ entitled “MULTI-DIMENSIONAL OBJECTS” and filed ______, the entirety of which is incorporated by reference.

### BACKGROUND

Objects are used extensively in software environments as a mechanism for bringing together data components and the procedures that operate on those data components. Objects are single-dimensional entities, where the object value or “actual data” is the single dimension. The actual data, also referred to as metadata, helps the system work with the application and a particular object.

When building personalization into a website, generally, a developer stores user preferences separately from the content that is to be personalized. More specifically, the developer writes logic that gets the customer preference details, retrieves the object that needs to be displayed, and then the user overlays the customer preferences on the object. However, this is problematic, in that there are multiple calls involved to the backend data store on which the object and value reside, and the developer has to write a substantial amount of code to show the personalized content on the webpage.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a way by which the developer can associate personalized information (e.g., user preferences) to the object that needs to be displayed in a custom way. The preferences are associated with the object as an inherent object dimension, in addition to the actual data (denoted as another dimension). The intrinsic actual data contained within the object itself is considered the first dimension, and additional data and/or metadata make up additional dimensions. Whenever the object is retrieved, the associated personal preferences as the inherent object dimension are returned with the object. The web developer simple uses the associated preferences to build the webpage. If no preferences were defined, the object can be configured to return with a default set of preferences.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented preferences system in accordance with the disclosed architecture.

FIG. 2 illustrates a preferences system that facilitates personalized preferences in accordance with the disclosed architecture.

FIG. 3 illustrates a computer-implemented preferences method in accordance with the disclosed architecture.

FIG. 4 illustrates further aspects of the method of FIG. 3.

FIG. 5 illustrates a block diagram of a computing system that executes personalized objects in accordance with the disclosed architecture.

FIG. 6 illustrates a schematic block diagram of a computing environment that supports personalized objects.

### DETAILED DESCRIPTION

The disclosed architecture provides user personal preferences information as a related dimension (also called referred to as metadata) to an object. The object includes the object value as an intrinsic first dimension, and the personalized information as an inherent second dimension.

In a robust implementation, the objects (e.g., .Net objects) can be stored in a distributed way in the cloud. That is, any object can be stored in and/or retrieved from a distributed interconnected directory of objects stored within the network (intranet or Internet). The objects stored in the distributed directory can be persisted within relational (e.g., SQL-structured query language) databases accessible through web services. Since the object is stored “in the cloud”, additional personalized information is stored as a dimension along with the object that allows more than a typical “in-memory” object.

The metadata on persisted objects is described in terms of dimensions. The intrinsic data contained within the object itself is considered the first dimension, and additional data and/or metadata comprise the additional dimensions. The architecture provides the ability to add, change, and/or modify the object within the network, and call applications with the inherent changes in realtime.

The cost of development is substantially reduced since the objects can be designed, stored, retrieved, and personalized within minutes by developers with lesser skills than otherwise would be needed to achieve the same functional results. Moreover, the risk of development is minimized, since the system is simple to use, and provides any enterprise and Internet capabilities for scale, performance, and reliability.

Consider the following example of a customer object First Name having an actual data value of Fred. A first user may want the customer's first name Fred to be shown in a specific, or first, color, or first font, on a webpage, and a second user may want the first name in a different, or second, color or second font. In operation, when the first user requests the First Name object for Fred, the webpage will present the first name Fred in the first color or first font. When the second user requests the First Name object for Fred, the webpage will present the first name Fred in the second color or second font. The first and second users will be presented with the corresponding personalized color or font when presented with the same webpage. In other words, the users each get the same object value back, but according to the associated piece of personalized information which defines their personal preferences for that object value. Thus, the disclosed architecture now enables the utilization of personalized data at a website, rather than personalizing the website pages or application.

Additionally, since preferences are now associated at the object level, the personalized information travels with the object and is not relegated to the website. For example, consider a user interface (UI) example of two websites where each site uses the same customer data, but each website design layout is different, with different colors, fonts, etc. Using the disclosed architecture, the object is not part of the website, but a third and separate entity that travels with the user. Thus, whatever the website visited by the user, the user's personal preferences come with by way of the relationship between the object and the personalized information. Accordingly, a website developer no longer needs to determine how to code a website for a given user's preferences.

Storing user preferences at the object level also provides consistency for the user as the user moves across sites. For example, if the user wants a green font for a specific object value, that personalized information is carried to the sites as well. This also has a positive impact on the user experience.

In yet another embodiment, personalization at the object level can have a positive impact on the non-UI user experience as well. Consider an agent process that is running on a server, and that the agent does not have a UI, but simply runs background tasks. Using the personalized information of a given user, the agent can run in the context of the user, thereby performing work for that user. When the agent is working for the user, the agent gets an object the user wants, which then processes the user's personalization information to influence the processing of that object, since the object data is relevant to the user and not a different user.

The user personalization can be provided in multiple ways. In a straight forward approach, the user chooses the user preferences. The object personalization can be as simple as background color, font, font size, etc., or more complex as RSS (really simple syndication) channels, stock tickers, etc. If a portal is using the personalized objects solution, the portal can request these preferences during user registration process.

In another approach, the preferences can be captured based on user actions. Over time, user actions can be captured on a website or network site, and based on the user's historical data and likes/dislikes. The objects can be auto-personalized so that the site is rendered using user preferences (likes).

Note that the disclosed solution is not limited to websites. Any application can utilize this approach to personalize the objects used in that application. Generally, the solution is about personalizing the object, and how the object is personalized depends on the use case of an application.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

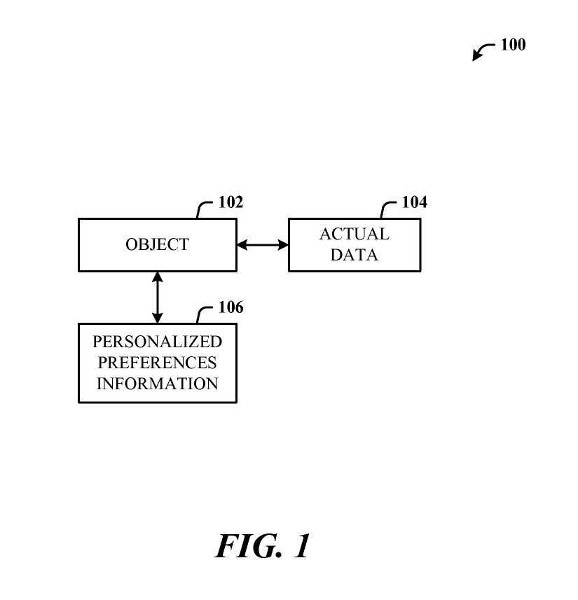

FIG. 1 illustrates a computer-implemented preferences system 100 in accordance with the disclosed architecture. The system 100 includes an object 102 in association with (or having) actual data 104 (a first inherent object dimension), and personalized preferences information 106 that is linked (e.g., intrinsically) to the object 102 such that a request associated with the object 102 returns the personalized preferences information 106. The personalized preferences information 106 is applied to the actual data 104. The personalized preferences information 106 is returned in response to a request for the object 102, the request intercepted by a handler. The actual data 104 is displayed according to display information contained in the personalized preferences information 106. The personalized preferences information 106 is stored with the object in a distributed directory. The object 102 and associated personalized preferences information 106 are accessible via web services. The object 102 is processed via a network environment. The process includes operations of adding, changing, or modifying. The operations are reflected in a calling application, in realtime. The object 102 is returned with a default set of preferences when no personalized preferences information is defined in association with the object 102.

As previously described, the solution provides a way to associate the user preferences (the personalized preferences information 106) with the object 102. The association can be by way of a database table, for example, that stores personal data. This table can then be related back to the object data. Any information can be attached, and in most cases, the database is agnostic as to the “shape” (format, type, etc.) of the data. The preferences data can be UI settings such as font, font size, or a simple comment added to annotate a part of the object data. Once added to the object, the database stores the data in the aforementioned table association. Note that the table is just one of many ways to store data in association with the object. One skilled in the art can employ other alternative and commonly known techniques for such purposes. Once associated, any process retrieving the object 102 will also receive the associated personalized preferences information 106.

More specifically, in a web example where the personalized dimension (the personalized preferences information 106) has font preferences, an HTTP (hypertext transfer protocol) Handler can intercept an HTTP request, fetch the preferences data, and generate a style sheet (e.g., CSS-cascading style sheets) that contains font classes, the style sheet generated based on the user's preferences (the personalized preferences information 106). Here, the web developer does not need to know anything about creating any specific code to personalize the page. As long as the web controls are using the same names for the style sheet classes, the dynamically generated style sheet will make the web control format according to the user preferences.

Consider an example where a Customer type also contains some customer specific details. During the registration process of the customer, the preferences information of the user is requested via the personalized dimension, such as font name, font size, background color, etc. Once the Customer data (the actual data 104) is saved and the preferences (the personalized preferences information 106) associated, whenever the user returns to the website, the user sees the site as per the preferences for that Customer object.

Following is an example of pseudo code for a conventional implementation of font preferences that does not employ associated personalized dimension:

// Read customer data
Webservice.Read(customer);
// Display using preferences
someWebControl1.Font = customer.Preferences.FontName;
someWebControl1.FontSize = customer.Preferences.Fontsize;
someWebControl2.BackgroundImage =
customer.Preferences.BackGroundImage;

In contrast, following is example pseudo code solution that employs the disclosed architecture for returning font preferences:

//Get back an instance of customer object from HTTP Handler
Customer.FirstName

Note that in the above pseudo code solution, there is no call to any middle tier service for retrieving the customer object and no lines of code setting up the web control CSS. All this is performed by the HTTP Handler, which gets the customer identifier from the request, retrieves the customer object from the store and then writes the style sheet to the response object. The preferences are retrieved along with the customer object due to the novel association. Neither is there a separate call to retrieve the preferences nor does the customer type contain a reference of type Preferences.

Put another way, a preferences system is provided having an object in association with actual data, and personalized preferences information that is intrinsically linked to the object such that a request associated with the object returns the personalized preferences information. The personalized preferences information is applied to the actual data in realtime. The personalized preferences information is returned in response to a request for the object, the request intercepted by an HTTP handler. The actual data is displayed according to display information contained in the personalized preferences information. The personalized preferences information is stored with the object in a distributed directory, the object and associated personalized preferences information are accessible via web services. The object is processed via a network environment, the processing includes operations of at least one of adding, changing, or modifying, the operations are reflected in a calling application in realtime. The object is returned with a default set of preferences when no personalized preferences are defined in association with the object.

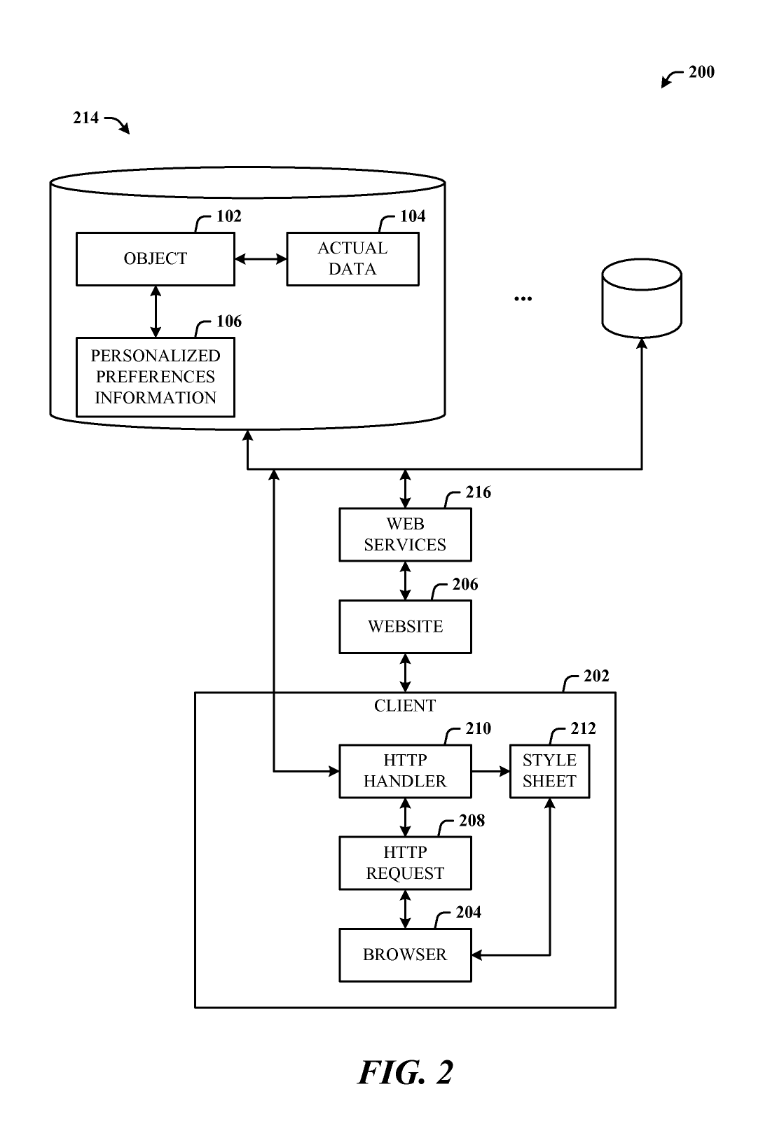

FIG. 2 illustrates a preferences system 200 that facilitates personalized preferences in accordance with the disclosed architecture. The system 200 includes a client 202 having a browser 204 via which to access a webpage of a website 206. The browser sends an HTTP request 208 to the website 206. An HTTP handler 210 intercepts the HTTP request 208, fetches the personalized preferences information 106, and generates a style sheet 212 that contains the personalized preferences information 106. The style sheet 212 is then applied to the webpage presented by the browser 204 to provide a personalized presentation of the actual data 104 of the object 102. The object 102 and associated personalized preferences information 106 is persisted in a distributed datastore 214 via the web services 216.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

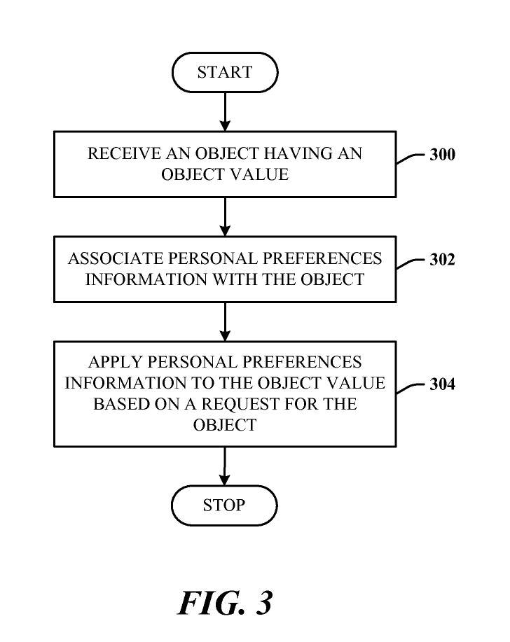

FIG. 3 illustrates a computer-implemented preferences method in accordance with the disclosed architecture. At 300, an object having an object value is received. At 302, personal preferences information is associated with the object. At 304, the personal preferences information is applied to the object value based on a request for the object.

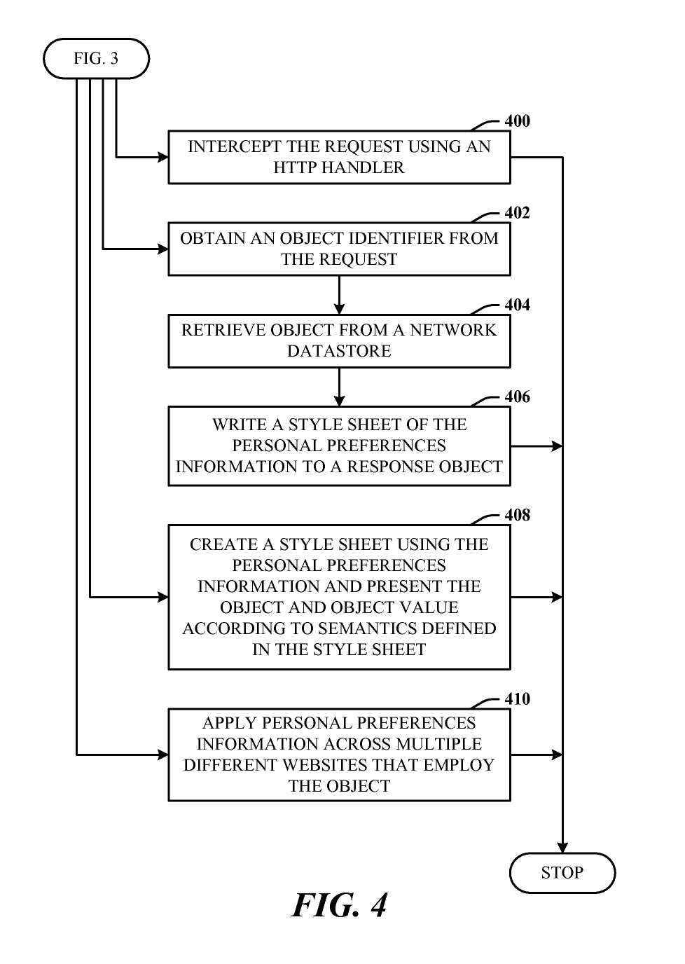

FIG. 4 illustrates further aspects of the method of FIG. 3. Note that the flow indicates that each block represents a step that can be included, separately or in combination with other blocks, as additional aspects of the method represented by the flow chart of FIG. 3. At 400, the request is intercepted using an HTTP handler. At 402, an object identifier is obtained from the request. At 404, the object is retrieved from a network datastore. At 406, a style sheet of the personal preferences information is written to a response object. At 408, a style sheet is created using the personal preferences information and presenting the object and object value according to semantics defined in the style sheet. At 410, the personal preferences information is applied across multiple different websites that employ the object.

As used in this application, the terms “component” and/or “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

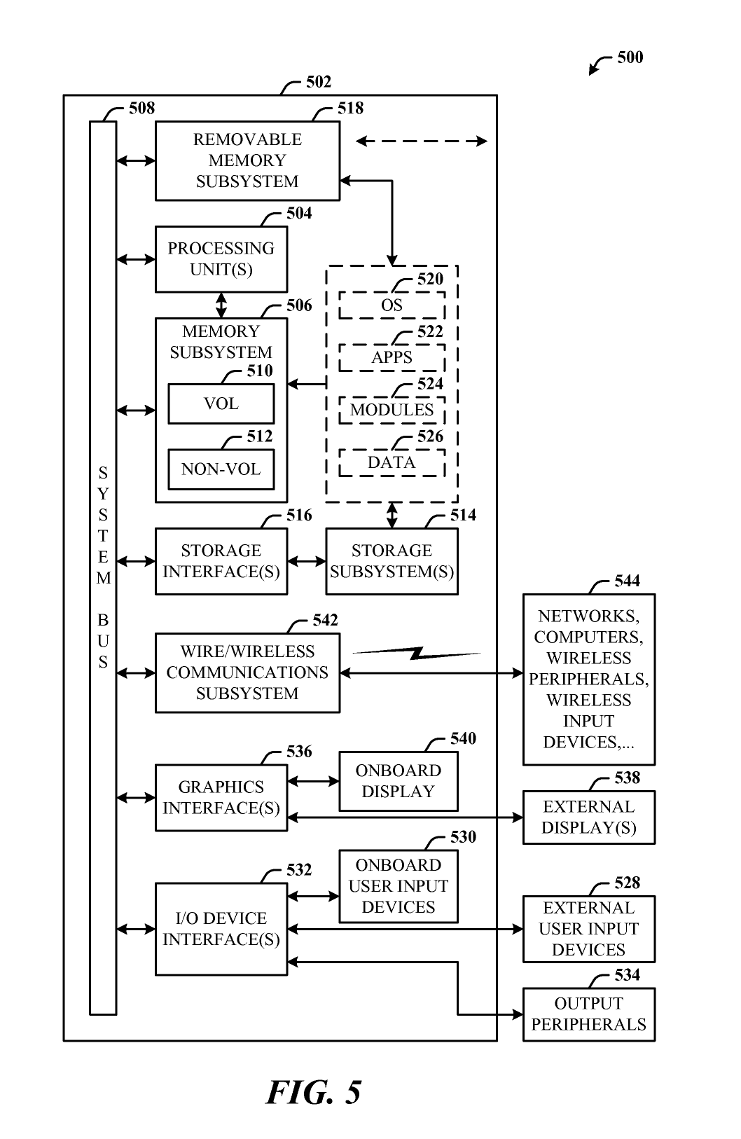

Referring now to FIG. 5, there is illustrated a block diagram of a computing system 500 that executes personalized objects in accordance with the disclosed architecture. In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504, a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The one or more application programs 522, other program modules 524, and program data 526 can include the entities and components of the system 100 of FIG. 1, the entities and components of the system 200 of FIG. 2, and the methods represented by the flowcharts of FIGS. 4 and 5, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 502 and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example. These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

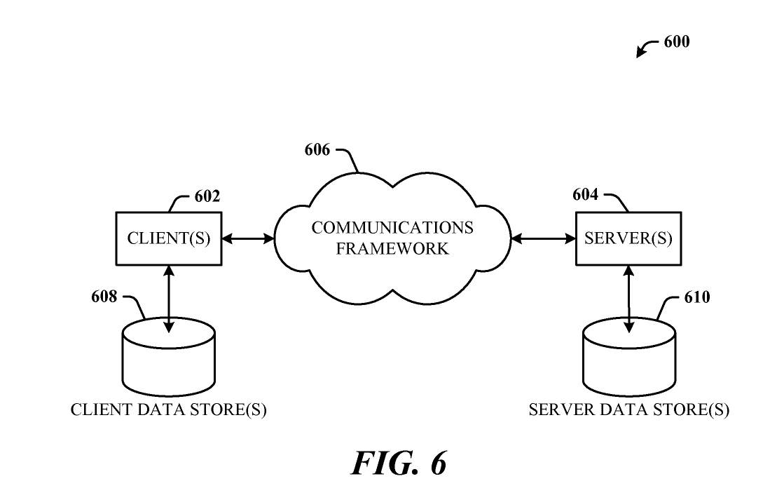

Referring now to FIG. 6, there is illustrated a schematic block diagram of a computing environment 600 that supports personalized objects. The environment 600 includes one or more client(s) 602. The client(s) 602 can be hardware and/or software (e.g., threads, processes, computing devices). The client(s) 602 can house cookie(s) and/or associated contextual information, for example.

The environment 600 also includes one or more server(s) 604. The server(s) 604 can also be hardware and/or software (e.g., threads, processes, computing devices). The servers 604 can house threads to perform transformations by employing the architecture, for example. One possible communication between a client 602 and a server 604 can be in the form of a data packet adapted to be transmitted between two or more computer processes. The data packet may include a cookie and/or associated contextual information, for example. The environment 600 includes a communication framework 606 (e.g., a global communication network such as the Internet) that can be employed to facilitate communications between the client(s) 602 and the server(s) 604.

Communications can be facilitated via a wire (including optical fiber) and/or wireless technology. The client(s) 602 are operatively connected to one or more client data store(s) 608 that can be employed to store information local to the client(s) 602 (e.g., cookie(s) and/or associated contextual information). Similarly, the server(s) 604 are operatively connected to one or more server data store(s) 610 that can be employed to store information local to the servers 604.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented preferences system having computer readable media that store executable instructions executed by a processor, comprising:
an object having actual data; and
personalized preferences information that is linked to the object such that a request associated with the object returns the personalized preferences information.

2. The system of claim 1, wherein the personalized preferences information is applied to the actual data.

3. The system of claim 1, wherein the personalized preferences information is returned in response to a request for the object intercepted by a handler.

4. The system of claim 1, wherein the actual data is displayed according to display information contained in the personalized preferences information.

5. The system of claim 1, wherein the personalized preferences information is stored with the object in a distributed directory.

6. The system of claim 1, wherein the object and associated personalized preferences information are accessible via web services.

7. The system of claim 1, wherein the object is processed via a network environment, the process includes operations of adding, changing, or modifying.

8. The system of claim 7, wherein the operations are reflected in a calling application in realtime.

9. The system of claim 1, wherein the object is returned with a default set of preferences when no personalized preferences are defined in association with the object.

10. A computer-implemented preferences system having computer readable media that store executable instructions executed by a processor, comprising:
an object in association with actual data; and
personalized preferences information that is linked to the object such that a request associated with the object returns the personalized preferences information, the personalized preferences information is applied to the actual data in realtime.

11. The system of claim 10, wherein the personalized preferences information is returned in response to a request for the object, the request intercepted by an HTTP (hypertext transfer protocol) handler.

12. The system of claim 10, wherein the actual data is displayed according to display information contained in the personalized preferences information.

13. The system of claim 10, wherein the personalized preferences information is stored with the object in a distributed directory, the object and associated personalized preferences information are accessible via web services.

14. The system of claim 10, wherein the object is processed via a network environment, the processing includes operations of at least one of adding, changing, or modifying, the operations are reflected in a calling application in realtime.

15. The system of claim 10, wherein the object is returned with a default set of preferences when no personalized preferences are defined in association with the object.

16. A computer-implemented preferences method executed by a processor, comprising:
receiving an object having an object value;
associating personal preferences information with the object; and
applying the personal preferences information to the object value based on a request for the object.

17. The method of claim 16, further comprising intercepting the request using an HTTP handler.

18. The method of claim 17, further comprising:
obtaining an object identifier from the request;
retrieving the object from a network datastore; and
writing a style sheet of the personal preferences information to a response object.

19. The method of claim 16, further comprising creating a style sheet using the personal preferences information and presenting the object and object value according to semantics defined in the style sheet.

20. The method of claim 16, further comprising applying the personal preferences information across multiple different websites that employ the object.
